(19) United States
(12) Patent Application Publication
(10) Pub. No.: US 2007/0039042 A1
(43) Pub. Date: Feb. 15, 2007

(54) Information-security systems and methods

(75) Inventor: Jacob Apelbaum, Sayville, NY (US)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: First Data Corporation, Englewood, CO (US)

(21) Appl. No.: 11/203,672

(22) Filed: Aug. 12, 2005

(51) Int. Cl. H04L 9/32

(52) U.S. Cl. 726/6

(57) ABSTRACT

Methods and systems are provided for managing passwords. The passwords are maintained in a database stored on a storage device. An interface is provided to a user on a display device to access at least one of the passwords from the database. The interface is generated with a computational device in communication with the storage device and with the display device. Periodic collection through the computational unit of a representation of a display on the display device is prevented.

### BACKGROUND OF THE INVENTION

This application relates generally to information security. More specifically, this application relates to methods and systems for secure management of access to software.

Maintaining the security of information systems is a persistent challenge. Efforts to do so often reflect an evolution of responses between those attempting to maintain system security and those attempting to breach it, with each developing methods to thwart the efforts of the others.

At its most basic level, security is usually implemented by requiring confirmation of a password to access a system. In such systems, which are commonplace and well known, a person wishing to gain access to an information system is prompted to supply a password, usually in combination with a username, and is given access only if the password can be verified by the system. While such an approach might seem superficially to provide the desired security, it is in fact subject to a number of well-known weaknesses.

First, there is a natural tendency for users to select passwords that they find relatively easy to remember. But the characteristics that make it easy for the user to remember the password also make the password more vulnerable to attack. This may be understood by considering the various ways in which an attacker might try to determine a user's password. Perhaps the simplest approach used by an attacker is to attempt to log onto a user's account by repeatedly guessing words and phrases known to have relevance to the user, such as her children's names, her or a relative's birth date, her favorite sports team or movie, etc. A more sophisticated technique may be described as an “online dictionary attack” in which an attacker uses an automated program that repeatedly attempts to use words from a text file to gain access to a system. A similar approach is an “offline dictionary attack, “in which an attacker obtains a copy of the file where hashed or encoded copies of user passwords are stored, and uses an automated program to determine the password for each account. An “offline brute-force attack” is a variation of such dictionary attacks, but uses an automated program that generates hashes or encrypted values for all possible passwords for comparison with values in the password file.

If the attacker has sufficient time, it is inevitable that trying all combinations of a sequence of characters of any length will discover each password. Thwarting such attempts often thus involves an attempt to make it combinatorially difficult so that the number of possible combinations that must be tried is so large that the task cannot practically be accomplished in a reasonable time. Increasing the number of possible combinations is typically achieved by increasing the average length of passwords and by using greater variety of characters, i.e. by using both upper- and lowercase characters, by using numerals, and by using other special characters that appear on conventional keyboards. The strength of the system is further enhanced by requesting or forcing users to change their passwords periodically.

As a practical matter, however, it is unreasonable to expect human users to memorize a 32-character random hexadecimal string on a monthly basis. But this is what is becoming necessary as computation power available to password crackers continues to increase. Furthermore, users are increasingly expected to remember greater numbers of passwords as their activities cause them to access an increasing variety of programs. Many users resort to keeping hard-copy records of their passwords in locations near their computers, thereby further compromising the effectiveness of using passwords.

There is accordingly a general need in the art for improved methods and systems for managing passwords.

### BRIEF SUMMARY OF THE INVENTION

Embodiments of the invention thus provide methods and systems for managing passwords. In a first set of embodiments, a method is provided of managing a plurality of passwords. The plurality of passwords are maintained in a database stored on a storage device. An interface is provided to a user on a display device to access at least one of the passwords from the database. The interface is generated with a computational device in communication with the storage device and with the display device. Periodic collection through the computational unit of a representation of a display on the display device is prevented.

In some instances, the computational device is further in communication with a keyboard used by the user to interact with the interface; in such cases, collection through the computational unit of a representation of a sequence of keystrokes executed by the user on the keyboard may be prevented. In other instances, the computational device is further in communication with a random-access memory used to store data temporarily while providing the interface; in such cases, collection through the computational unit of data stored in the random-access memory may be prevented. The computational unit may also be configured to provide clipboard functionality for copying and pasting data; in such embodiments, collection through the computational unit of data on the clipboard may be prevented.

A substantially random password may be generated in response to a request by the user. In some embodiments, the substantially random password conforms to a password profile policy that ensures the password is one of at least 275 possible passwords. The password may also sometimes comprise a representation of a biometric measurement.

In one embodiment, a computer application is launched on the computational device in response to a request from the user. At least one of the passwords selected by the user is provided to the computer application so that the user gains access to the computer application.

The plurality of passwords may be maintained in the database in encrypted form. For example, a master password may be received. The master password is hashed with a salt value to produce a result. The result is successively hashed with a salt value to produce a new result, with the new result generated after N such hashings being a master key. For each of the plurality of passwords, a userid associated with the each of the plurality of passwords is encrypted with the master key and a userid salt value. The each of the plurality of passwords is also encrypted with the master key and a password salt value. The encrypted userid and encrypted password are stored on the storage device.

In a second set of embodiments, a method is also provided for managing a plurality of passwords. A master password is received. The master password is hashed with a salt value to produce a result. The result is successively hashed with a salt value to produce a new result, with the new result generated after N such hashings being a master key. For each of the plurality of passwords, a userid associated with the each of the plurality of passwords is encrypted with the master key and a userid salt value. The each of the plurality of passwords is also encrypted with the master key and a password salt value. The encrypted userid and encrypted password are stored on a storage device.

In some such embodiments, the master key may be further encrypted with a certification salt value to produce a certification key, with the certification key being stored on the storage device. A purported master password may be received and verified by hashing the purported master password with a salt value to produce a purported result. The purported result is successively hashed with a salt value to produce a purported new result, the purported new result generated after N such hashings being a purported master key. The purported master key is encrypted with the certification salt value to produce a purported certification key, permitting a determination whether the purported certification key is equivalent to the certification key.

In some embodiments, each of the plurality of passwords conforms to a password profile polity that ensures that each of the plurality of passwords is one of at least 2⁷⁵ possible passwords. At least one of the passwords may be generated substantially randomly in response to a request by a user. Also, at least one of the passwords may comprise a representation of a biometric measurement.

In one embodiment, a computer application is launched in response to a request from a user. At least one of the passwords selected by the user is then provided to the computer application so that the user gains access to the computer application.

The method may be implemented on a computational unit, with the method further comprising at least one of several steps. First, periodic collection of a representation of a display generated by the computational unit for display on a display unit in communication with the computational unit may be prevented. Second, a sequence of keystrokes executed on a keyboard in communication with the computational unit may be prevented. Third, collection of data stored in a random-access memory used by the computational unit to store data temporarily may be prevented. Fourth, collection of data on a clipboard implemented by the computational unit for copying and pasting data may be prevented.

The methods of the invention described above may be embodied in a computer-readable storage medium having a computer-readable program embodied therein. The computer-readable program directs operation of a computer system to manage a plurality of passwords. The computer system include a computational unit and a storage device, with the computer-readable program including instructions to implement the methods as described above.

### BRIEF DESCRIPTION OF THE DRAWINGS

A further understanding of the nature and advantages of the present invention may be realized by reference to the remaining portions of the specification and the drawings wherein like reference numerals are used throughout the several drawings to refer to similar components.

FIGS. 1A-1C are flow diagrams illustrating methods of the invention in certain embodiments;

FIGS. 2A-2E are examples of screen views that may be provided to a user during execution of the methods of FIGS. 1A-1C;

FIGS. 3A and 3B are flow diagrams illustrating methods of securing passwords in some embodiments;

FIG. 4 is a flow diagram illustrating the use of certain anti-spyware techniques in embodiments of the invention; and

FIG. 5 provides a schematic representation of a computational unit that may be used to provide secure access management in accordance with embodiments of the invention.

### DETAILED DESCRIPTION OF THE INVENTION

Embodiments of the invention provide a centralized software application for maintaining password information for users. The software application provides administrative functions that allow a user to store multiple passwords for different applications and to generate passwords automatically. Removing the need to remember passwords permits the user to have passwords with greater complexity and length, and such characteristics may be ensured by implementing a password profile policy that imposes certain minimal criteria on passwords maintained by the application. In addition, the software application may invoke an anti-spyware program that protects users from having the passwords intercepted by certain spyware techniques. Embodiments of the invention make use of anti-spyware techniques that prevent the type of information collected by spyware to be obtained, rather than using a conventional approach of identifying recognizable signatures of spyware.

As used herein, a “password” refers broadly to any sequence or arrangement of information used to gain access that is otherwise restricted. It is noted, in particular, that biometrics are thus examples of passwords, albeit passwords that are more complex than more traditional character-string passwords. “Biometrics” themselves are records of one or more physical characteristics of a user, such as records of fingerprints, retinal structures, hand-geometry structures, and the like. When measured from a user, the records of such physical characteristics provide an arrangement of information used to gain access that is otherwise restricted. In many instances, measurements of actual physical characteristics of people may change over time and/or as a result of the measurement technique. The use of biometrics thus provides an example of passwords that need not be provided identically in order to gain access, provided that the proffered password (such as in the form of a current fingerprint measurement) be consistent with the expected password within a predetermined confidence level.

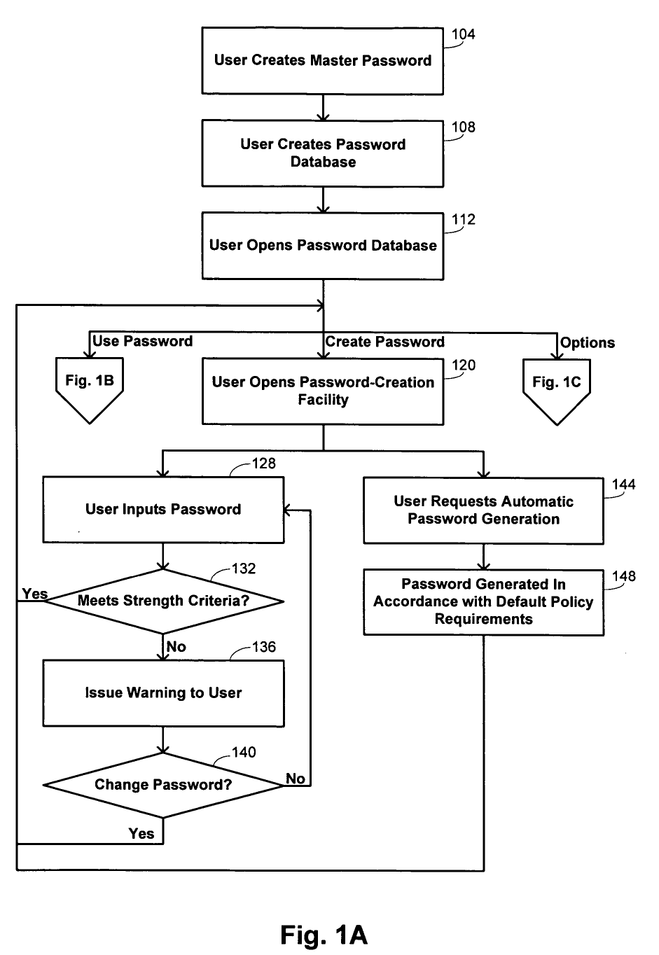

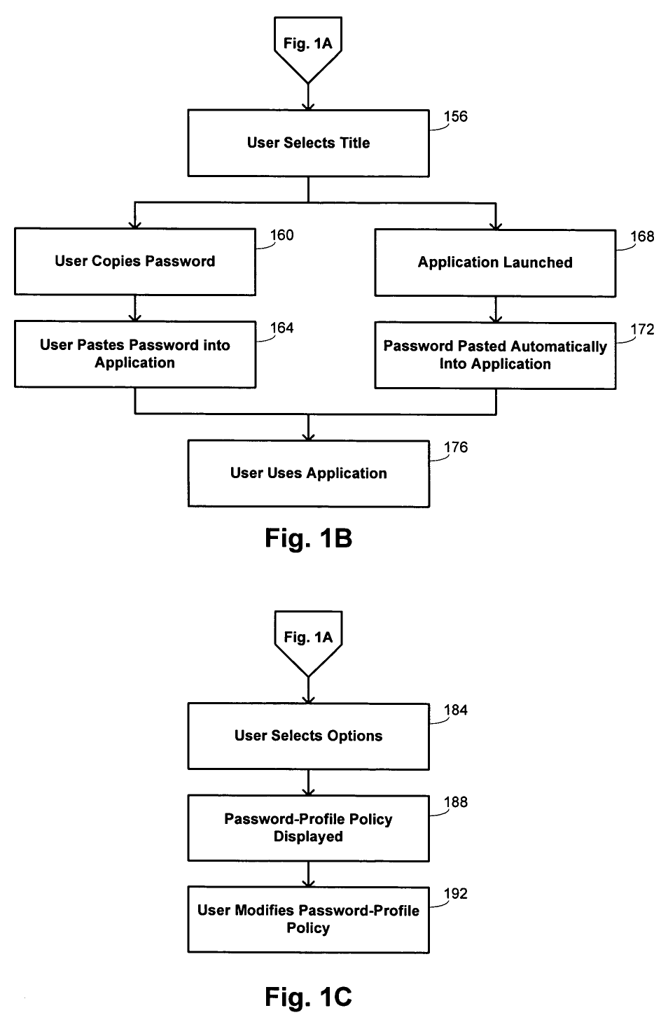

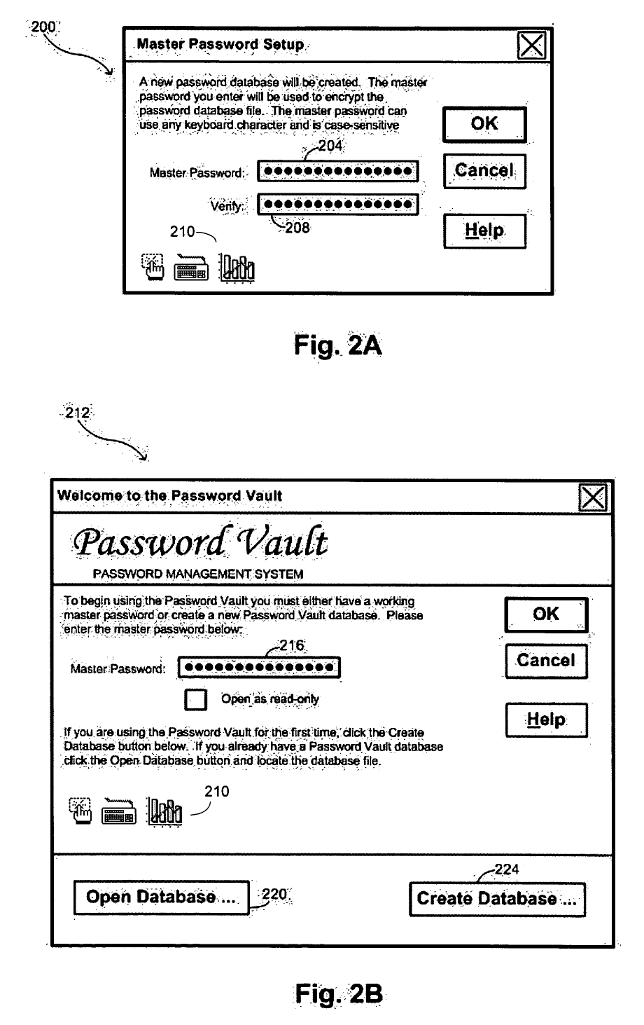

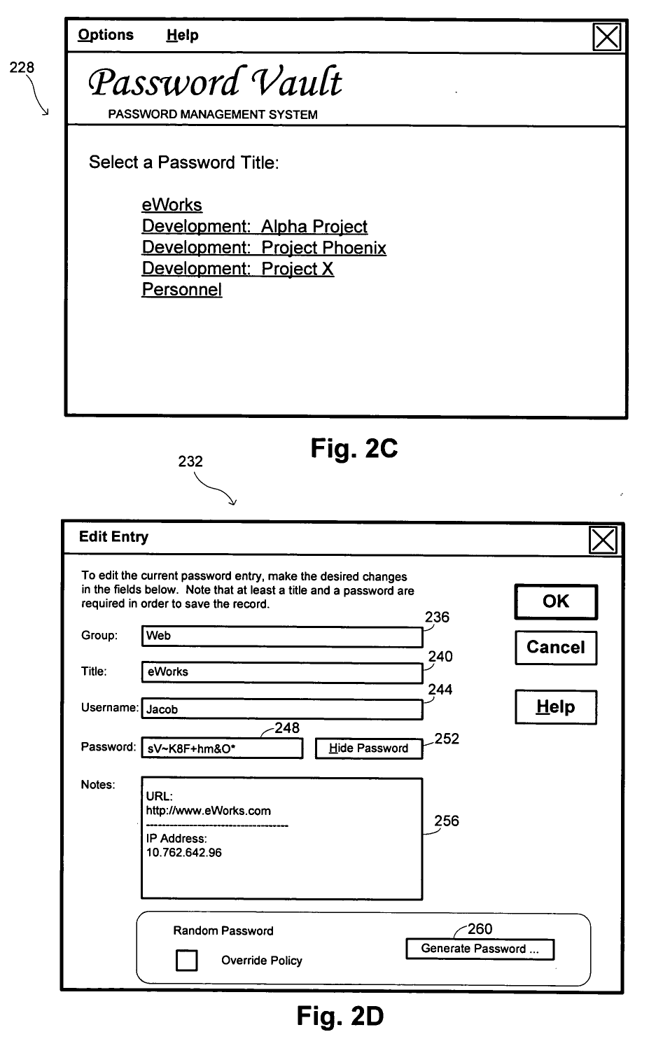

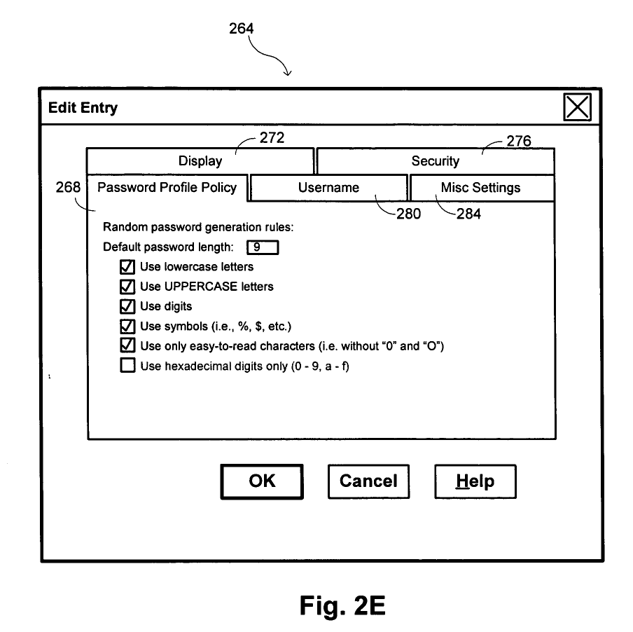

An overview of how the centralized software application functions is provided with the flow diagrams of FIGS. 1A-1C, with certain features being illustrated in exemplary screen views shown in FIGS. 2A-2E. The flow diagrams set forth certain functionality in a particular order for purposes of illustration, but there is no requirement that the functions be performed in the illustrated order. Also, embodiments of the invention need not necessarily include all of the functions illustrated and may sometimes include additional functions not specifically illustrated.

The method begins at block 104 with a user creating a master password that will subsequently permit the user to gain access to the password management facility. Other passwords that the user might use to gain access to other applications will be managed by the password management facility, so the user need remember only a single password. FIG. 2A provides an exemplary view of a screen 200 that may be presented to the user, requesting entry of the master password in field 204, with entry of a confirmation of the master password in field 208. Techniques for protecting the master password from an attacker are explained in detail below. Different methods for creating the master password and for selecting a corresponding authentication method may be used in different embodiments, as designated by icons 210. In one embodiment, the password may be typed via a keyboard. In another embodiment, the password may be provided using a biometric reader such as a fingerprint reader. In a further embodiment, a user's typing profile on the keyboard may be analyzed by having the user type a common phrase and comparing typing scores.

Once the user has been provided with access to the password management facility in this manner (or in an alternative manner), she may use the master password to manage one or more password databases. The user accesses the system through an access screen such as shown in FIG. 2B. The access screen 212 includes a field 216 for providing the master password and includes mechanisms 224 and 220 for creating a password database and for opening an existing password database, activities performed respectively at blocks 108 and 112 of FIG. 1A. A screen like that shown in FIG. 2C may be generated in response to the user activating the open-database mechanism 220 at block 112, the screen 228 showing a list of existing password databases for that user. The database identifications may have active links to a screen like that shown in FIG. 2D. This screen 232 provides an edit facility that may be used to input details initially describing a password and may be used subsequently for an existing password managed by the facility to change details about the password.

Thus, if the user is initially creating a password, such a screen 232 may be displayed without populated fields when the user opens the password-creating facility at block 120. Some of the fields shown in FIG. 2D are intended to be exemplary by illustrating the type of information that may be provided in defining a password. This includes, for example, the group field 236, which may allow the user to specify an assignment of the password according to an internal organizational structure. Other fields include a title field 240 in which a convenient and informative title for the password may be provided. The assignment of titles to passwords with the title field 240 greatly simplifies the task for the user by using easy and meaningful identifications to identify specific passwords.

The actual access information for a particular application is defined by the username 244 and password 248 fields, with an option 252 being provided to hide the password from display even in the edit screen 232 to enhance security. A notes field 256 permits recordation of supplementary information, such as the URL where the password is to be used, telephone numbers for an organization implementing the application, and any other information that the user might find helpful in managing the password.

When initially storing a password in the database, the user may either provide a password selected herself or may have a password generated automatically. It is generally anticipated that users will more frequently use passwords generated by the system when having access to such a facility since the passwords are then more likely to have characteristics that make them resistant to cracking, without the user being burdened with memorizing a difficult-to-remember password. If the user does elect to provide her own password, however, this may be entered by the user at block 128 of FIG. 1A. The password management facility checks at block 132 whether the password input by the user meets defined strength criteria, which may require, for example, that it be of a certain minimum length and have a certain minimum complexity. If the password provided by the user does not meet such criteria, it may be rejected and the user required to enter a new password that is checked according to the same criteria. Alternatively, the user may be issued a warning that the password is deficient at block 136, with the user being given an opportunity at block 140 to change the password or to keep the selected password by declining to change the password.

If the user instead requests automatic generation of a password at block 144, such as by activating the feature 260 shown in FIG. 2D to do so, the password management facility generates a password automatically at block 148 that conforms with the default password policy requirements. In some instances, a capability may be provided to override the password policy so that the system generates a password that is not necessarily in strict conformity with such requirements. Such a capability is useful for passwords to be used in applications that do not accept complex passwords.

Once the user has established one or more passwords to be maintained by the password management facility, the facility may be used in accessing those passwords and perhaps also in accessing the applications where those passwords apply. Such processes are illustrated in FIG. 1B, with the user being presented with a selection of password titles from which a desired selection may be made at block 156. In embodiments where the user launches the application separately, the password management facility may function passively as a secure storage receptacle for the passwords. At block 160, the user is then provided with an opportunity to copy the password so that it may be pasted into the appropriate application at block 164. In embodiments where the application is launched automatically by selecting the password title, as indicated at block 168, the password is pasted into the application automatically at block 172. Either approach permits the user to perform functions with the application at block 176, having been authenticated by the application using a password supplied by the password management facility.

The password management facility may also include a number of options that may be changed by a user as illustrated in FIG. 1C. The capability to do so is initiated when the user selects an “Options” menu item at block 184, being presented with an options screen like the one shown in FIG. 2E. The options screen 264 may permit a number of different types of options to be adjusted, including display features 272, security features 276, username features 280, and various miscellaneous settings 284. The screen 264 shows, in particular, that there may be an ability to change the password profile policy, which typically defines certain password-generation rules. For example, the password profile policy may specify a default password length and may specify whether to include certain types of characters in the password, such as lowercase letters, uppercase letters, digits, symbols, easy-to-read characters, hexadecimal digits, and the like. The password-profile policy is displayed to the user at block 188, with the user having the capability of modifying the password-profile policy at block 192.

Examples of the security options that may be provided include an option to clear the clipboard whenever the password management facility is minimized or exited. This makes sensitive password information that may have been copied to the clipboard inaccessible. Another option may lock the password management facility whenever it is minimized, with sensitive information such as the master password and the titles of passwords being cleared from memory upon minimization; the user is prompted for the master password when the password management facility is restored. Other security options may comprise notifications. For instance, the password management facility may be configured generally to save the password database whenever it is minimized. In some instances, an option permits the user to be reminded, and perhaps also confirm the save, whenever this happens. Similarly, an option may provide for a notification whenever a password is copied to the clipboard.

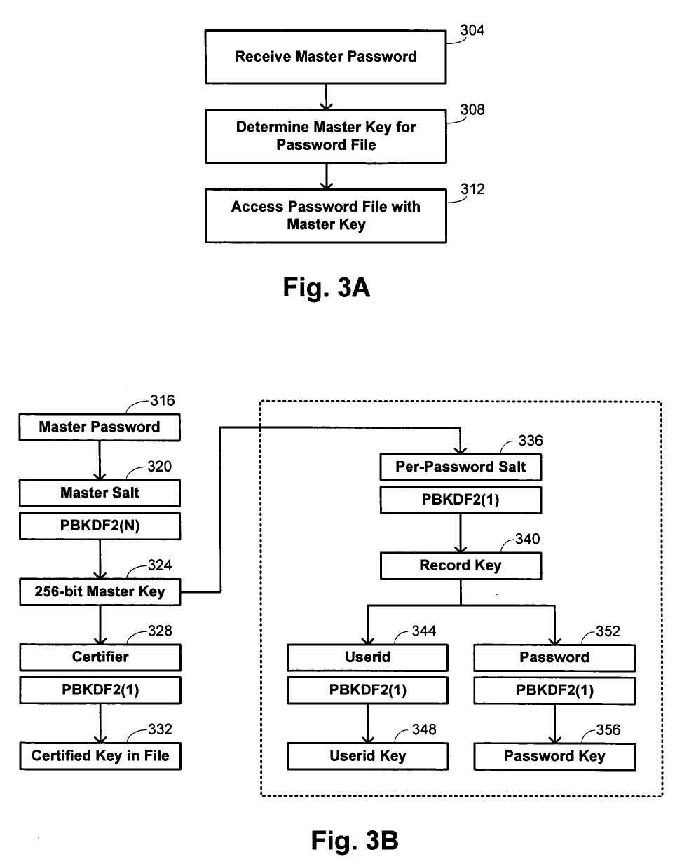

Considerable security may also be provided in embodiments of the invention by “stretching” the password, a technique that strengthens the password to make it even more difficult to determine from a brute-force attack. Some techniques for password stretching are described in the Public Key Cryptography Standards (“PKCS”) promulgated by RSA Laboratories, particularly in PKCS #5 for password-based cryptography, the entire disclosure of which is incorporated herein by reference for all purposes. To provide access to the password management facility, then, the master password is received at block 304 of FIG. 3A so that a master key for a password file maintained by the facility may be determined at block 308. The password file is then accessed with the master key at block 312, permitting the functionality described above to be implemented.

There are a number of different ways in which the master key may be determined from the master password. For example, in one embodiment, the master key may be calculated simply by hashing the master password and taking some number of bits, say 128 bits, of that hash value as the key. If hashing is considered to be a single step that can be performed in one clock cycle by someone who has specialized hardware, then an attacker would need over 14 million years to hash all possible keys of a twelve-character password on a 3-GHz machine at 279 clock cycles.

In another embodiment, the Password Based Key Derivation Function 2 (“PBKDF2”) is applied by running a cryptographic pseudorandom number generator repeatedly, seeded with the master password and with a salt value. Instead of hashing just once, the password is hashed many times by seeding a cryptographic pseudorandom number generator with the master password and with a salt value. With each round, the generator produces output that is subjected to an exclusive-or operation into the final result. Merely by way of example, the pseudorandom number generator may comprise the 256-bit version of the Secure Hash Algorithm (“SHA-256”), although other pseudorandom number generators may be used in alternative embodiments. In one implementation, 2^{N} iterations of the SHA-256 algorithm are applied repeatedly to the master password, effectively adding N bits of security to the password. Currently, a suitable value for N is about 15-20, although N may conveniently be increased to augment the security if necessary or desired.

The manner in which such password stretching enhances security may be understood by considering an attacker who obtains a copy of the password file for the password management facility. Such an attacker could then mount a brute-force attack by trying every possible master password, calculating the master key, and decrypting one of the passwords in the list. An indication that the correct master password has been discovered is that the decrypted password results in a plaintext byte stream that represents a password in a unicode formatting, such as in UTF-8 encoding. That the correct master password has been discovered may then be confirmed by using the master key to decrypt other passwords in the same fashion, verifying that they too result in plaintext byte streams that represent a password in unicode formatting.

Stretching the password greatly increases the number of attempts that the attacker will have to make before discovering the correct password. For instance, consider a master password having a length of twelve characters, containing no words found in a dictionary, and included a combination of upper- and lowercase letters, numbers, and punctuation. Each character then comes from a possible set of 94 characters (26+26+10+32) if drawn from a standard English keyboard, so that the password is one of 94¹²≅2⁷⁹ possible passwords. While a 79-bit key is already quite strong, stretching the password additionally forces the attacker to perform 2^{N} iterations of a pseudorandom number generator, thereby greatly increasing the work needed in performing a brute-force attack. If N=21, say, the brute-force attack will take 2¹⁰⁰ steps instead of 2⁷⁹ steps, and the value of N may be increased further to stretch the password even more and make it still stronger.

An illustration of how this procedure may be applied is provided with the flow diagram of FIG. 3B. The password management facility uses a unique key to encrypt each piece of data stored in the password file, with the keys being derived from the master key, which is in turn derived from the master password as described above. Derivation of the master key in this way is illustrated with blocks 316-324: in an embodiment using PBKDF2, the master password 316 is subjected to repeated hashing with a salt value and PBKDF2 algorithm Ntimes at block 320 to generate the master key 324. A record key 340 is derived from the master key 324 by application of a random per-password salt value with a single PBKDF2 hash at block 336. This record key 340 is then split into the two keys that are used to encrypt the userid 344 and password 352 respectively for that record, the result being a userid key 348 and a password key 356 that are stored in the password file.

A certification key 332 may also be generated to be used in verifying the master password through application of a certifier value 328 as the salt value. The certification key 332 is stored in the password file so that each time a user enters a purported master password, a purported certified key may be calculated by reapplying the sequence in FIG. 3B, allowing the purported certified key to be compared with the certified key stored in the password file. Because the certified key 332 is produced from the master key 324 via one-way hash operations, the value of the certifier 328 cannot be used by an attacker to deduce the master key 324.

While the above processes provide significant security to the passwords stored by the password management facility, it is noted that it is generally prudent to provide a multilayered defense by limiting access to the files used by the password management facility. For example, the password file might be kept in a directory where access controls limit the number of people who can access the file.

Still further security may be provided in some embodiments by implementing background antispyware programming. The use of such antispyware programming acts to prevent attackers from circumventing the cryptographic security by monitoring user behavior to determine the master password and individual userids and passwords. While traditional antispyware programming looks for recognizable signatures, embodiments of the invention use a different paradigm for antispyware programming by individually blocking access to the types of information sought by spyware programs. It is thus largely irrelevant which spyware programs may have infiltrated a given system and which techniques they may use since the information that they attempt to extract will be unavailable.

Several different types of information have been identified as potential sources of information and the antispyware programming includes separate functionality to block access to each of these. A first source of information is found in keyboard strokes, with certain spyware applications having a keyboard logger that creates a hook into the keyboard driver of a computer. The keyboard strokes executed by a user are thereby recorded and later routed to the attacker so that the attacker can analyze the keyboard strokes. Another source of information is found in the display provided to the user. Some spyware applications attempt to extract this information by taking a screen shot periodically, such as once per second, and saving the screen shots in a file that is later transmitted to the attacker for replay. Other types of spyware processes may focus on tracking data stored in memory. For example, a memory-traversing spyware program uses the fact that RAM is used store data when a process is launched. A search is made for memory strings, which may be encrypted or unencrypted, and dumped for later analysis by the attacker. A similar tactic is used by spyware that collects data stored on clipboard monitors, with the spyware program potentially collecting both text and graphics.

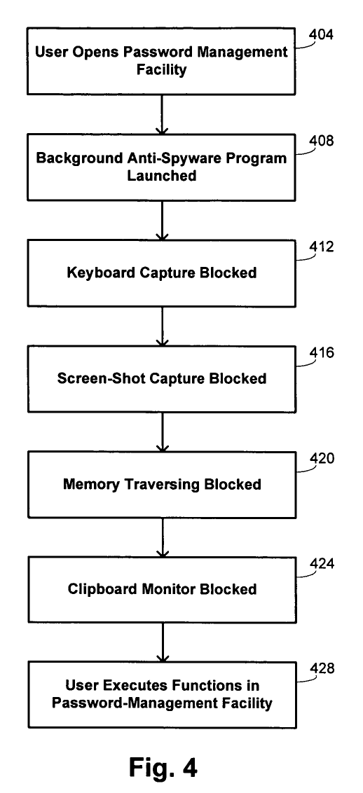

Functionality performed when antispyware designed to intercept each of these types of information is illustrated with the flow diagram of FIG. 4. At block 404, the user opens the password management facility, prompting a launch of the background antispyware program at block 408. The antispyware program blocks keyboard capture at block 412, blocks screen-shot capture at block 416, blocks memory traversing at block 420, and blocks clipboard monitoring at block 424. It is not necessary that every one of these types of blocking be included, and in some embodiments only a subset of such blocking functions might be included. With these processes running in the background, the user executes functions in the password management facility at block 428. This antispyware support thus provides additional protection to the passwords maintained with the password management facility.

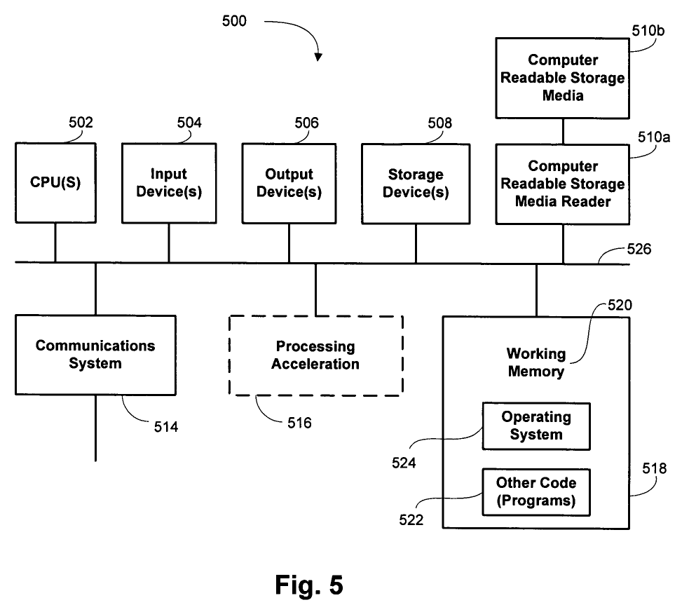

Methods of the invention described herein may be embodied on a computational device such as illustrated schematically in FIG. 5, which broadly illustrates how individual system elements may be implemented in a separated or more integrated manner. The computational device 500 is shown comprised of hardware elements that are electrically coupled via bus 526. The hardware elements include a processor 502, an input device 504, an output device 506, a storage device 508, a computer-readable storage media reader 510a, a communications system 514, a processing acceleration unit 516 such as a DSP or special-purpose processor, and a memory 518. The computer-readable storage media reader 510a is further connected to a computer-readable storage medium 510b, the combination comprehensively representing remote, local, fixed, and/or removable storage devices plus storage media for temporarily and/or more permanently containing computer-readable information. The communications system 514 may comprise a wired, wireless, modem, and/or other type of interfacing connection and permits data to be exchanged with external devices. The storage devices typically hold information defining the stored spectra as well as any personalized-setting information that may be used.

The computational device 500 also comprises software elements, shown as being currently located within working memory 520, including an operating system 524 and other code 522, such as a program designed to implement methods of the invention. It will be apparent to those skilled in the art that substantial variations may be used in accordance with specific requirements. For example, customized hardware might also be used and/or particular elements might be implemented in hardware, software (including portable software, such as applets), or both. Further, connection to other computing devices such as network input/output devices may be employed.

Having described several embodiments, it will be recognized by those of skill in the art that various modifications, alternative constructions, and equivalents may be used without departing from the spirit of the invention. Accordingly, the above description should not be taken as limiting the scope of the invention, which is defined in the following claims.

What is claimed is:

1. A method of managing a plurality of passwords, the method comprising:
maintaining the plurality of passwords in a database stored on a storage device;
providing an interface to a user on a display device to access at least one of the passwords from the database, wherein the interface is generated with a computational device in communication with the storage device and with the display device; and
preventing periodic collection through the computational unit of a representation of a display on the display device.

2. The method recited in claim 1 wherein the computational device is further in communication with a keyboard used by the user to interact with the interface, the method further comprising preventing collection through the computational unit of a representation of a sequence of keystrokes executed by the user on the keyboard.

3. The method recited in claim 1 wherein the computational device is further in communication with a random-access memory used to store data temporarily while providing the interface, the method further comprising preventing collection through the computational unit of data stored in the random-access memory.

4. The method recited in claim 1 wherein the computational device is configured to provide clipboard functionality for copying and pasting data, the method further comprising preventing collection through the computational unit of data on the clipboard.

5. The method recited in claim 1 further comprising generating a substantially random password in response to a request by the user.

6. The method recited in claim 5 wherein the substantially random password conforms to a password profile policy that ensures the password is one of at least 2⁷⁵ possible passwords.

7. The method recited in claim 1 wherein the password comprises a representation of a biometric measurement.

8. The method recited in claim 1 further comprising:
launching a computer application on the computational device in response to a request from the user; and
providing at least one of the passwords selected by the user to the computer application so that the user gains access to the computer application.

9. The method recited in claim 1 wherein maintaining the plurality of passwords in the database comprises maintaining the plurality of passwords in encrypted form.

10. The method recited in claim 1 further comprising:
receiving a master password;
hashing the master password with a salt value to produce a result;
successively hashing the result with a salt value to produce a new result, wherein the new result generated after N such hashings is a master key; and
for each of the plurality of passwords,
encrypting a userid associated with the each of the plurality of passwords with the master key and a userid salt value;
encrypting the each of the plurality of passwords with the master key and a password salt value; and
storing the encrypted userid and encrypted password on the storage device.

11. A computer-readable storage medium having a computer-readable program embodied therein for directing operation of a computer system to manage a plurality of passwords, the computer system including a computational unit, a storage device and a display device, wherein the computer-readable program includes:
instructions to maintain the plurality of passwords in a database stored on the storage device;
instructions to provide an interface to a user on the display device to access at least one of the passwords from the database; and
instructions to prevent periodic collection through the computational unit of a representation of a display on the display device.

12. The computer-readable storage medium recited in claim 11 wherein:
the computer system further includes a keyboard in communication with the computational unit; and
the computer-readable program further includes instructions to prevent collection through the computational unit of a representation of a sequence of keystrokes executed by the user on the keyboard.

13. The computer-readable storage medium recited in claim 11 wherein:
the computer system further includes a random-access memory used to store data temporarily while providing the interface; and
the computer-readable program further includes instructions to prevent collection through the computational unit of data stored in the random-access memory.

14. The computer-readable storage medium recited in claim 11 wherein:
the computational device is configured to provide clipboard functionality for copying and pasting data; and
the computer-readable program further includes instructions to prevent collection through the computational unit of data on the clipboard.

15. The computer-readable storage medium recited in claim 11 wherein the computer-readable program further includes;
instructions to launch a computer application in response to a request from the user; and
instructions to provide at least one of the passwords selected by the user to the computer application so that the user gains access to the computer application.

16. The computer-readable storage medium recited in claim 11 wherein the computer-readable program further includes:
instructions to receive a master password;
instructions to hash the master password with a salt value to produce a result;
instructions to successively hash the result with a salt value to produce a new result, wherein the new result generated after N such hashings is a master key;
instructions to encrypt each of a plurality of userids with the master key and a userid salt value, the each of the plurality of userids being associated with one of the plurality of passwords;
instructions to encrypt each of the plurality of passwords with the master key and a password salt value; and
instructions to store the encrypted each of the plurality of userids and the encrypted each of the plurality of passwords on the storage device.

17. A method of managing a plurality of passwords, the method comprising:
receiving a master password;
hashing the master password with a salt value to produce a result;
successively hashing the result with a salt value to produce a new result, wherein the new result generated after N such hashings is a master key; and
for each of the plurality of passwords,
encrypting a userid associated with the each of the plurality of passwords with the master key and a userid salt value;
encrypting the each of the plurality of passwords with the master key and a password salt value; and
storing the encrypted userid and encrypted password on a storage device.

18. The method recited in claim 17 further comprising:
encrypting the master key with a certification salt value to produce a certification key; and
storing the certification key on the storage device.

19. The method recited in claim 18 further comprising:
receiving a purported master password;
hashing the purported master password with the salt value to produce a purported result;
successively hashing the purported result with a salt value to produce a new purported result, wherein the new purported result generated after N such hashings is a purported master key;
encrypting the purported master key with the certification salt value to produce a purported certification key; and
determining whether the purported certification key is equivalent to the certification key.

20. The method recited in claim 17 wherein the each of the plurality of passwords conforms to a password profile policy that ensures that each of the plurality of passwords is one of at least 2⁷⁵ possible passwords.

21. The method recited in claim 17 further comprising generating at least one of the passwords substantially randomly in response to a request by a user.

22. The method recited in claim 17 wherein at least one of the passwords comprises a representation of a biometric measurement.

23. The method recited in claim 17 further comprising:
launching a computer application in response to a request from a user; and
providing at least one of the passwords selected by the user to the computer application so that the user gains access to the computer application.

24. The method recited in claim 17 wherein the method is implemented on a computational unit, the method further comprising a step selected from the group consisting of:
preventing periodic collection of a representation of a display generated by the computational unit for display on a display unit in communication with the computational unit;
preventing collection of a sequence of keystrokes executed on a keyboard in communication with the computational unit;
preventing collection of data stored in a random-access memory used by the computational unit to store data temporarily; and
preventing collection of data on a clipboard implemented by the computational unit for copying and pasting data.

25. A computer-readable storage medium having a computer-readable program embodied therein for directing operation of a computer system to manage a plurality of passwords, the computer system including a computational unit and a storage device, wherein the computer-readable program includes:
instructions to receive a master password at the computational unit;
instructions to hash the master password with a salt value to produce a result;
instructions to successively hash the result with a salt value to produce a new result, wherein the new result generated after N such hashings is a master key;
instructions to encrypt each of a plurality of userids with the master key and a userid salt value, the each of the plurality of userids being associated with one of the plurality of passwords;
instructions to encrypt the each of the plurality of passwords with the master key and a password salt value; and
instructions to store the encrypted each of the plurality of userids and the encrypted each of the plurality of passwords on the storage device.

26. The computer-readable storage medium recited in claim 25 wherein the computer-readable program further includes:
instructions to encrypt the master key with a certification salt value to produce a certification key; and
instructions to store the certification key on the storage device.

27. The computer-readable storage medium recited in claim 26 wherein the computer-readable program further includes:
instructions to receive a purported master password at the computational unit;
instructions to hash the purported master password with the salt value to produce a purported result;
instructions to successively hash the purported result with a salt value to produce a new purported result, wherein the new purported result generated after N such hashings is a purported master key;
instructions to encrypt the purported master key with the certification salt value to produce a purported certification key; and
instructions to determine whether the purported certification key is equivalent to the certification key.

28. The computer-readable storage medium recited in claim 25 wherein the computer-readable program further includes;
instructions to launch a computer application in response to a request from the user; and
instructions to provide at least one of the passwords selected by the user to the computer application so that the user gains access to the computer application.

29. The computer-readable storage medium recited in claim 25 wherein the computer readable program includes a set of instructions selected from the group consisting of:
instructions to prevent periodic collection of a representation of a display generated by the computational unit for display on a display device in communication with the computational unit;
instructions to prevent collection of a sequence of keystrokes executed on a keyboard in communication with the computational unit;
instructions to prevent collection of data stored in a random-access memory used by the computational unit to store data temporarily; and
instructions to prevent collection of data on a clipboard implemented by the computational unit for copying and pasting data.
